(19) United States
(12) Patent Application Publication
(10) Pub. No.: US 2015/0305103 A1
(43) Pub. Date: Oct. 22, 2015

(54) DRIVER FOR SOLID STATE LIGHT SOURCES

(71) Applicant: OSRAM SYLVANIA INC., Danvers, MA (US)

(72) Inventors: Tanay Shah, San Jose, CA (US); Anil Jeswani, Beverly, MA (US)

(73) Assignee: OSRAM SYLVANIA Inc., Danvers, MA (US)

(21) Appl. No.: 14/439,646

(22) PCT Filed: Nov. 5, 2013
(86) PCT No.: PCT/US2013/068596

§ 371 Date: Apr. 29, 2015

Related U.S. Application Data
(60) Provisional application No. 61/722,610, filed on Nov. 5, 2012.

(51) Int. Cl. H05B 33/08

(52) U.S. Cl. CPC H05B 33/0815; H05B 33/0896

(57) ABSTRACT

Techniques are disclosed for providing an adaptive and scalable output drive current by a lighting driver, which helps mitigate issues related to binning of solid state light sources. The disclosed techniques may be implemented, for example, with the use of header pins and one or more jumpers or so-called shunt connectors. This allows for a given driver with a constant current output to provide any number of desired output drive currents on demand, by switching and/or adding and/or removing one or more shunt connectors across the appropriate header pins. The header may include any number of pin-pairs, with each pin-pair capable of receiving a shunt connector. Any number of driver topologies may be implemented with the header, such as flyback, buck, boost, buck-boost, and variants thereof.

### CROSS-REFERENCE TO RELATED APPLICATION

The present application claims priority of U.S. Provisional Patent Application No. 61/722,610, filed Nov. 5, 2012 and entitled “DRIVER FOR SOLID STATE LIGHT SOURCES”, the entire contents of which are hereby incorporated by reference.

### TECHNICAL FIELD

The present invention relates to lighting, and more specifically, to electronic drivers for solid state light sources.

### BACKGROUND

A typical solid state lighting system generally includes one or more power supplies or so-called drivers and a solid state light source such as one or more light emitting diodes (LEDs). In some cases, a single multi-channel driver is provided to power multiple LED strings (one string per channel), while in other cases a plurality of single channel drivers are provided so that each driver can power a given LED string (one string per driver). Depending on factors such as semiconductor process variables associated with the LED manufacturing process as well as variations in material lots used, a given LED (or other solid state light source) operating in a given lighting system may appear different from other LEDs operating in that same lighting system, even in the case where the LEDs are within the same product line and/or product family line.

### SUMMARY

Embodiments disclose an adaptive and scalable output drive current by a lighting driver, which helps mitigate issues related to binning of solid state light sources. The disclosed techniques may be implemented, for example, with the use of header pins and one or more jumpers or so-called shunt connectors. This allows for a given driver with a constant current output to provide any number of desired output drive currents on demand, by switching and/or adding and/or removing one or more shunt connectors across the appropriate header pins. The header may include any number of pin pairs, with each pin pair capable of receiving a shunt connector. Any number of driver topologies may be implemented with the header, such as flyback, buck, boost, buck-boost, etc.

As previously noted, solid state light sources in a given lighting installation may appear different from one another, even when they are from the same product line or product family. To maintain a nominal system lumen output within an acceptable range (say, +/−10%) of nominal rated lumens for a desired correlated color temperature (CCT), one of two options is typically employed. The first option includes the use of so-called flux binning and the second option involves the use of multiple driver channels. In more detail, and with respect to the first option, manufacturers of solid state light sources such as LEDs use a binning system in effort to minimize such perceptible differences in appearance at a given installation, where LEDs that are within a relatively narrow range of appearance are grouped together in a so-called flux bin. In general, light sources from a given flux bin will not have any human-perceptible differences in appearance. Using light sources from a range of neighboring flux bins for a given installation may also provide a very similar or otherwise acceptable appearance, but perceptible differences will become apparent with greater distance between the bins used. To this end, so-called premium flux binning involves selecting a few of all available flux bins, which results in a correspondingly higher per unit cost. Costs are generally lowest when light sources from all available flux bins are purchased, rather than cherry picking from a few flux bins. Further note that some vendors are unable or otherwise unwilling to meet such requests, as the inventory management aspects of binning may be burdensome. The second option involves the use of dedicated driver channels so as to provide one output drive current per each given solid state light source flux bin being used. Thus, the actual light sources received may be grouped (according to their respective flux bins) at the light fixture manufacturing plant or installation site so similarly binned light sources are driven by an independently controlled channel. Each driver channel current at a given installation is then set to drive its corresponding light source so as to provide a consistent appearance with other independently controlled light sources at that installation. However, this solution effectively moves the burden from the solid state light source manufacturer to the lighting system manufacturer or the light installer, and is similarly associated with increased development and manufacturing costs, and tends to reduce manufacturing throughput given the need for channel-bin matching. Regardless of which option is used, the issues become more prominent and further augmented as the lumen output increases and/or as the number of discrete solid state light sources used increases.

Thus, embodiments provide a driver that is configured with an adaptive and scalable output drive current, which helps mitigate issues related to binning of solid state light sources. Embodiments may be and are implemented, for example, with the use of header pins and one or more shunt connectors. This allows for a driver with a constant current output to provide any number of desired output drive currents on demand, by switching and/or adding and/or removing one or more shunt connectors across the appropriate header pins. Further, embodiments allow modules, lamps, and luminaires including solid state light sources to be built with very tight tolerance on the light output irrespective of CCT without significantly impacting design and/or manufacturing costs. Embodiments are used to allow multiple lumen packages or lighting products to be offered with a common driver design, so there is no need to have dedicated drivers for each product line.

The header block is provided, in some embodiments, on a substrate including other driver components, or on a dedicated substrate configured to operatively couple with a given driver circuit. The header block may include any number of pin pairs, with each pin pair configured to be capable of receiving, and in some embodiments to receive, a shunt connector. Multiple shunt connectors may be installed onto the header block, in some embodiments. Alternatively, some embodiments may call for no shunt connectors on the header block, which as will be appreciated in light of this disclosure also results in a particular output drive current.

Thus, depending on the number of pin pairs that are shunted (connected together) or not shunted, a driver configured as described herein can provide two or more possible output drive currents. In such embodiments, a constant current driver configured with a multi-pin header block and shunt connector combination is used to provide multiple drive currents on demand. Depending on the flux bins associated with the incoming solid state light sources at the manufacturing plant, one or more shunt connectors on the header are set to the desired position(s) to achieve target system lumens (e.g., +/−10% of nominal) for a given CCT. Embodiments may be scaled to any power level (or drive current), and any number of discrete current settings. Some embodiments allow for up to six different current settings, and are implemented with a header block of three pin pairs, each comprising two pins.

Lighting drivers may be pre-fabricated with a header block in place, except that the jumpers need not be installed. Alternatively, all the jumpers are installed for purposes of simplifying packaging and shipping. Regardless, jumpers may be and are installed and/or removed according to the need for a given application (based on factors such as available flux bins, CCT, and lumen package, among others) at the time of assembly at a factory of a lighting system manufacturer or at an installation site. As such, manufacturing lead time and cost are decreased accordingly, as is development effort, time and cost. In addition, embodiments are implemented with any number of existing driver designs (e.g., flyback, buck, boost, buck-boost, etc).

In an embodiment, there is provided a method. The method includes: receiving input power at a light driver circuit comprising a plurality of output channels, wherein the plurality of output channels comprises a first output channel and a second output channel; setting an output current for at least a first output channel and a second output channel in the plurality of output channels by using a respective multi-pin header block, such that an output current of the first output channel of the light driver circuit is set by using a first multi-pin header block and an output current of the second output channel of the light driver circuit is set by using a second multi-pin header block; and providing the output current of the first output channel to a first light source and the output current of the second output channel to a second light source.

In a related embodiment, providing may include providing the output current of the first output channel to a first light source, associated with a first flux bin and the output current of the second output channel to a second light source associated with a second flux bin. In another related embodiment, setting may include using one of the first multi-pin header block and the second multi-pin header block to divert a portion of a total current associated with a respective output channel in the plurality of output channels corresponding to the used multi-pin header block from being provided to a respective light source associated with the respective output channel.

In still another related embodiment, setting may include using one of the first multi-pin header block and the second multi-pin header block to set a primary-side current of a respective isolation transformer corresponding to a respective output channel in the plurality of output channels corresponding to the used multi-pin header block. In yet another related embodiment, the method may further include connecting the first multi-pin header block in series with the first light source and connecting the second multi-pin header block in series with the second light source.

In still yet another related embodiment, setting may further include installing or removing a shunt connector from at least one of the first multi-pin header block and the second multi-pin header block, wherein a position of a shunt connector on the first multi-pin header block is different from a position of a shunt connector on the second multi-pin header block.

In another embodiment, there is provided a driver. The driver includes: a first converter stage configured with a first output channel to provide a current to a first light source; and a first multi-pin header block configured to set the current of the first output channel, including a plurality of first pin-pairs, each capable of receiving a shunt connector.

In a related embodiment, the driver may further include: a second converter stage configured with a second output channel to provide a current to a second light source; and a second multi-pin header block configured to set the current of the second output channel, including a plurality of second pin-pairs, each capable of receiving a shunt connector. In a further related embodiment, the first light source may be associated with a first flux bin, and the second light source may be associated with a second flux bin. In another further related embodiment, the second multi-pin header block may divert a portion of a total current of the second converter stage from being provided to the second light source.

In still another further related embodiment, the second converter stage may include an isolation transformer, and the second multi-pin header block may set a primary-side current of the isolation transformer.

In another related embodiment, the driver may further include an input stage to condition input power and to provide the conditioned input power to the first converter stage. In yet another related embodiment, the first multi-pin header block may divert a portion of total current of the first converter stage from being provided to the first light source. In still another related embodiment, the first converter stage may include an isolation transformer, and the first multi-pin header block may set a primary-side current of the isolation transformer.

In yet still another related embodiment, the first multi-pin header block may be configured to be electrically connected in series with the first light source. In still yet another related embodiment, the driver may further include a controller configured to sense current through the first light source and to take a control action, wherein the control action may include directing placement of a shunt connector on the first multi-pin header block.

In another embodiment, there is provided a lighting system. The lighting system includes: a first converter stage configured with a first output channel to provide a current to a first light source; a first multi-pin header block configured to set the current of the first output channel, and including a plurality of first pin-pairs, each capable of receiving a shunt connector; a second converter stage configured with a second output channel to provide a current to a second light source; and a second multi-pin header block configured to set the current of the second output channel, and including a plurality of second pin-pairs, each capable of receiving a shunt connector; wherein at least one of the current of the first output channel and the current of the second output channel is set by installing and/or removing one or more shunt connectors from at least one of the first multi-pin header block and the second multi-pin header block; and wherein the first converter stage and the second converter stage are implemented with a single multi-channel driver or two single-channel drivers.

In a related embodiment, at least one of the first multi-pin header block and the second multi-pin header block may divert a portion of a total current of the corresponding converter stage from being provided to the corresponding light source. In another related embodiment, at least one of the first converter stage and the second converter stage may include an isolation transformer, and the corresponding multi-pin header block may set a primary-side current of the corresponding isolation transformer. In still another related embodiment, the system may further include a controller configured to sense a current through the first light source and to take a control action, wherein the control action includes directing placement of a shunt connector on the first multi-pin header block.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a block diagram illustrating a lighting system having a driver configured according to embodiments disclosed herein.

FIG. 2A schematically illustrates a driver topology configured according to embodiments disclosed herein.

FIG. 2B schematically illustrates a driver topology configured according to embodiments disclosed herein.

FIG. 2C schematically illustrates a driver topology configured according to embodiments disclosed herein.

FIG. 3A illustrates a top view of a substrate configured according to embodiments disclosed herein.

FIG. 3B illustrates a perspective view of a portion of the substrate of FIG. 3A including a header block without a shunt connector according to embodiments disclosed herein.

FIG. 3C illustrates a perspective view of a portion of the substrate of FIG. 3B including a header block having a shunt connector installed according to embodiments disclosed herein.

### DETAILED DESCRIPTION

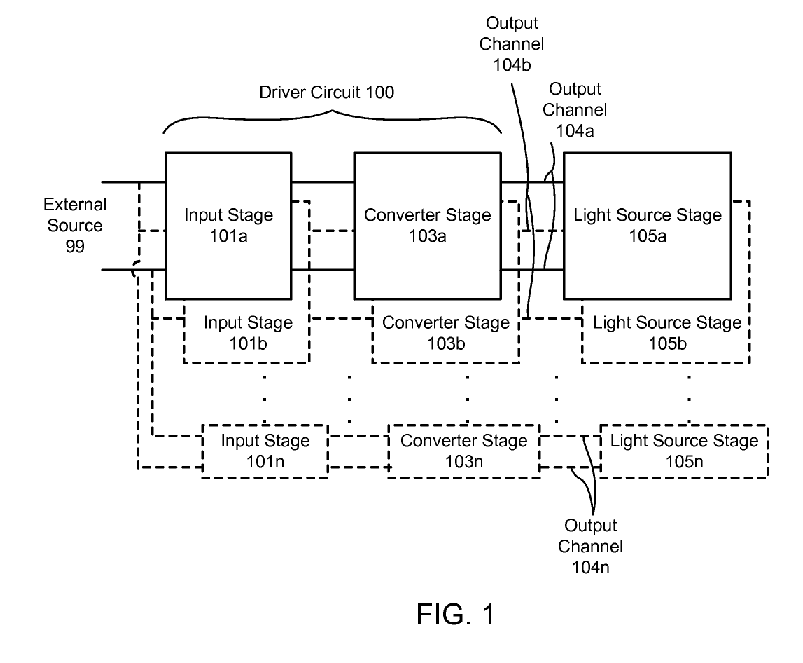

FIG. 1 is a block diagram illustrating a lighting system having a driver circuit 100 operatively coupled to one or more light source stages 105a, 105b, . . . 105n. The driver circuit 100 includes n input stages 101a, 101b, . . . 101n, each configured to condition an external source 99 of power, and n converter stages 103a, 103b, . . . 103n, each configured with a shuntable (that is, adjustable) drive current. In some embodiments, an input stage 101a receives power from an external source 99 of power, such as but not limited to an AC power source, and is configured to provide power factor correction (PFC) including rectification and any needed filtering. Other embodiments may and do include one or more input stages 101a, 101b, . . . 101n configured to receive a DC power source or both an AC and a DC power source, as will be appreciated. Each of the input stages 101a, 101b, . . . 101n in turn provides appropriately conditioned energy to a corresponding converter stage 103a, 103b, . . . 103n, which generally operate to provide a requisite amount of power to the corresponding light source stage 105a, 105b, . . . 105n. FIG. 1 also shows n output channels 104a, 104b, . . . 104n capable of providing n distinct drive currents (not shown) for n distinct light sources, namely the light source stages 105a, 105b, . . . 105n. These n output channels are, in some embodiments, for example, the channels of a single multi-channel driver, and in other embodiments are the outputs of n single channel drivers, or some combination of multi and single channel drivers.

In some embodiments, each converter stage 103a, 103b, . . . 103n includes a switching element that is responsive to a corresponding microcontroller or other suitable processor (not shown in FIG. 1). The switching element is controlled to tailor brightness (dimming) and/or to implement a desired lighting schedule (e.g., on during 7 am-7 pm; otherwise off) for that particular output channel 104a, 104b, . . . 104n. The control signal provided to the switching element is, in some embodiments, for example, a pulse width modulation (PWM) signal that turns on and off a corresponding one of the converter stages 103a, 103b, . . . 103n to create a PWM modulated drive current on the corresponding one of the output channels 104a, 104b, . . . 104n. In addition, each of the converter stages 103a, 103b, . . . 103n, and in some embodiments a subset thereof, is configured to modify the drive current that is output on the corresponding output channels 104a, 104b, . . . 104n. In some embodiments, this current control is statically accomplished with a multi-pin header block.

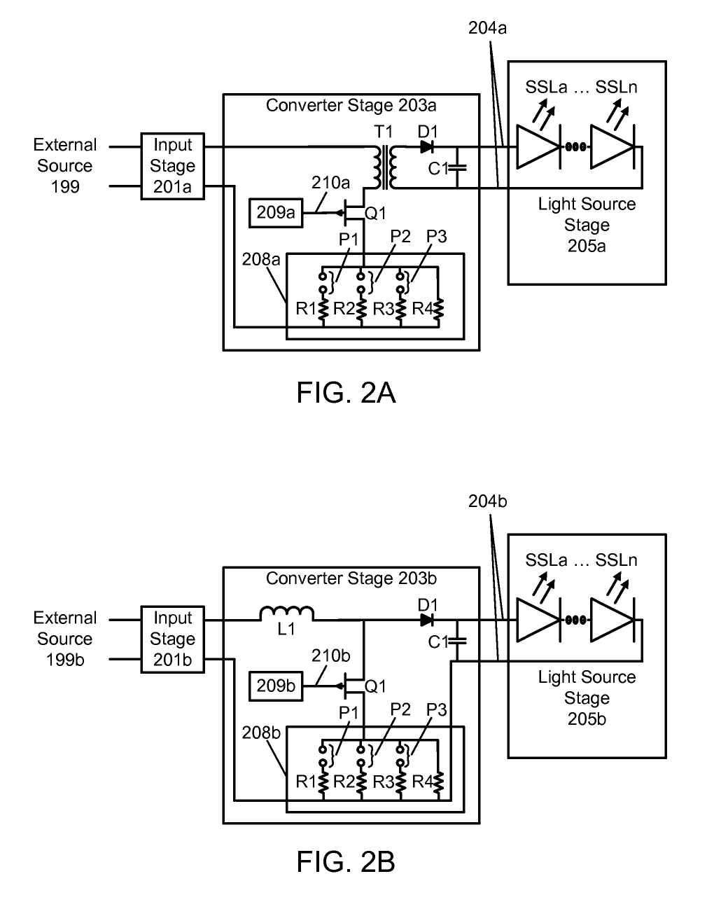

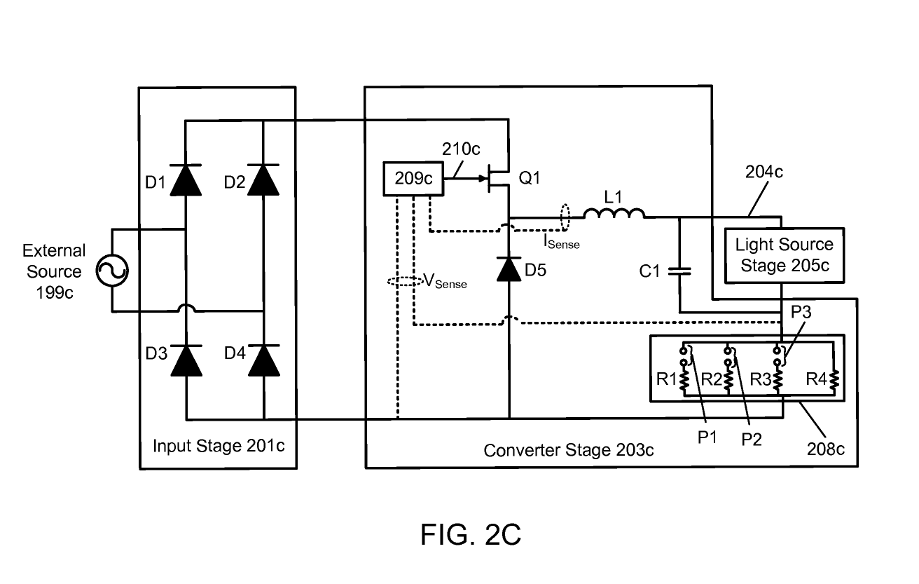

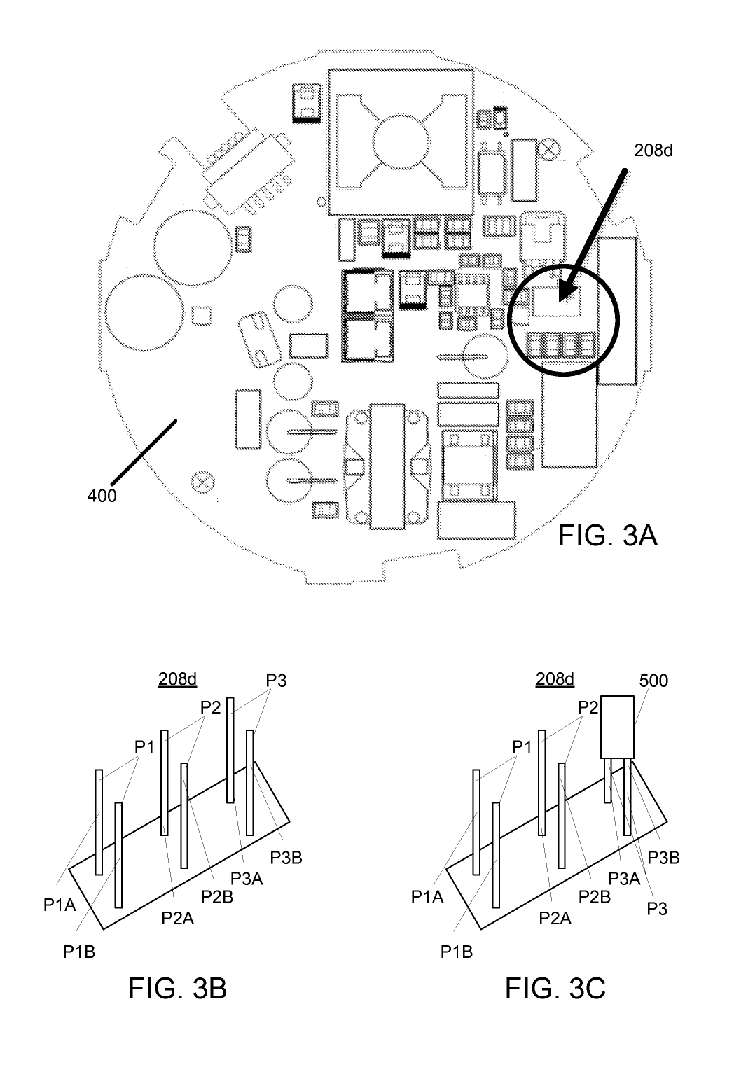

For example, in some embodiments, such as where one or more converter stages 103a, 103b, . . . 103n have a topology configured with an isolation transformer (e.g., a flyback topology), a multi-pin header block is used to effectively set the drive current on the output of a secondary-side of the isolation transformer, and thus the current on the corresponding output channel, by setting the current on a primary-side of the isolation transformer, depending on placement of a shunt connector on the multi-pin header block. In some embodiments where one or more converter stages 103a, 103b, . . . 103n have a topology that includes an inductor (e.g., buck and boost topologies), a multi-pin header block is connected in parallel with one or more of the light source stages 105a, 105b, . . . 105n (i.e., one or more loads) and is used to set the current on the corresponding output channel 104a, 104b, . . . 104n by diverting a portion of that current from the output, depending on placement of a shunt connector on the multi-pin header block. In some embodiments, a multi-pin header block is connected in series with one or more of the light source stages 105a, 105b, . . . 105n (i.e., one or more loads) and is used to set the current on the corresponding output channel 104a, 104b, . . . 104n, depending on placement of a shunt connector on the multi-pin header block. Note that current through an inductor is able to be sensed by a local microcontroller, which in some embodiments then takes a control action to manage the current flow and possibly direct a user with respect to shunt connector placement on the multi-pin header block. In a similar fashion, the voltage across the load and/or the multi-pin header block is also capable of being sensed by a local microcontroller and thus is also, in some embodiments, used to trigger one or more control actions. Examples of such embodiments are discussed in greater detail below with further reference to FIGS. 2A-2C and 3A-3C.

The light source stages 105a, 105b, . . . 105n are implemented with any suitable number of solid state light sources, such as but not limited to light emitting diodes (LEDs), organic light emitting diodes (OLEDs), polymer light emitting diodes (PLEDs), organic light emitting compounds (OLECs), and the like, in series or parallel or combinations thereof. In some embodiments, each of the light source stages 105a, 105b, . . . 105n is implemented with a string of three to thirty solid state light sources electrically connected in series, though of course strings having more or less solid state light sources are used in other embodiments. Features of the solid state light sources, such as but not limited to brightness, chromaticity, color, and so on, are selected as desired. Any number of configurations of the solid state light sources are possible. In such embodiments, the output currents of the driver circuit 100 are statically manipulated or tuned as provided herein to minimize appearance differences associated with light sources from multiple flux bins.

In some embodiments, one or more functions associated with one or more of the input stages 101a, 101b, . . . 101n are integrated with a corresponding one or more of the converter stages 103a, 103b, . . . 103n, even though FIG. 1 depicts the input stage 101a as being separate from the converter stage 103a. Similarly, in some embodiments, one or more of the input stages 101a, 101b, . . . 101n and/or the converter stages 103a, 103b, . . . 103n are integrated with one or more of the light source stages 105a, 105b, . . . 105n. In some embodiments, there is no input stage 101a, such as where no rectification or power factor correction is needed for a given application. Any suitable input stage 101a is used in some embodiments to condition power provided as input to the converter stage 103a. In some embodiments, additional modules or stages not shown in FIG. 1 are included, such as but not limited to an electromagnetic interference (EMI) stage, an input protection stage, an output protection stage, one or more stages required to comply with one or more given regulatory schemes, or any other stages. The topology of the converter stage 103a and the converter stage 103b are the same in some embodiments and different in others, and this is possible for any grouping of converter stages 103a, 103b, . . . 103n, and also vary between embodiments, so long as the output current on the corresponding output channel 104a, 104b, . . . 104n is able to be changed by setting (or not setting, as the case may be) the appropriate on the corresponding multi-pin header block.

FIG. 2A schematically illustrates a topology for a converter stage 203a. An input stage 201a is configured to receive power from an external source 199 of power, and to rectify and filter the received power to provide an input to the converter stage 203a. The converter stage 203a is configured with a flyback topology, including a transformer T1, a diode D1, a capacitor C1, and a switching element Q1 that is responsive to a control signal 210a from a microcontroller 209a. The converter stage 203a also includes a multi-pin header block 208a. The load connected to converter stage 203a is a light source stage 205a, which includes a string of solid state light sources SSLa . . . SSLn. The transformer T1 includes a primary side that is connected to the input stage 201a and to a source of the switching element Q1, which is shown in FIG. 2A as a p-channel type MOSFET. A gate of the switching element Q1 is connected to the microcontroller 209a. A drain of the switching element Q1 is connected to the multi-pin header block 208a, which is also connected to the input stage 201a. A secondary side of the transformer T1 is connected to an anode of the diode D1, and a cathode of the diode D1 is connected to the light source stage 205a. The capacitor C1 is connected in parallel across the secondary side of the transformer T1.

In operation, the microcontroller 209a provides the control signal 210a to the gate of the switching element Q1, causing the switching element Q1 to close, which results in a primary current flowing through the primary side of the transformer T1, and thus the transformer T1 stores energy. The amount of energy stored in the transformer T1 depends on the shunt resistance. A voltage induced in the secondary winding of the transformer T1 is negative, so the diode D1 is reverse-biased, and the output capacitor C1 supplies energy to the light source stage 205a. When the switching element Q1 is opened by the control signal 210a from the microcontroller 209a, the primary current of the transformer T1 suddenly drops to zero. Magnetic flux will be maintained in the transformer T1 and due to voltage balance of the secondary side of the transformer T1, the polarity of the transformer T1 will change, thereby forward biasing the diode D1 and recharging the capacitor C1. Current will then flow to the light source stage 205a. As will be appreciated, when the transformer T1 is a flyback transformer, as in FIG. 2A, a flyback transformer is different from a conventional transformer in that a flyback transformer stores the energy during the on-time of the switching element Q1 and discharges during the off-time of the switching element Q1. As will be further appreciated, when the converter stage 203a is configured in a flyback topology, as shown in FIG. 2A, it operates in a similar fashion to a buck-boost topology, except that the transformer T1 is replaced with an inductor (not shown).

The multi-pin header block 208a of FIG. 2A includes four resistors R1, R2, R3, and R4 in parallel, with the resistor R4 always connected and the remaining resistors R1, R2, and R3 connectable via a corresponding pin pair P1, P2, and P3 for each. By adding a shunt connector (not shown in FIG. 2A) across one or more of the pin pairs P1, P2, and P3, the corresponding resistor R1, R2, and/or R3 is connected, while removing an existing shunt connector from a pin pair disconnects the corresponding resistor. Thus, the multi-pin header block 208a is configured to set the current through the primary side of the transformer T1, which in turn sets the current of the secondary side of the transformer T1, which is provided to the light source stage 205a via an output channel 204a. Thus, the multi-pin header block 208a sets the output current on the output channel 204a. The resistor R4, because it is always in circuit, gives protection to the converter stage 203a and saves the converter stage 203a from a no connection scenario, such as may occur if a shunt connector is mistakenly not installed. If there is a mistaken connector scenario, that is, if a connector is not at the desired location on the multi-pin header block 208a (e.g., across the wrong pin pair P1, P2, P3), the unit including that converter stage 203a will fail standard electrical tests, triggering an inspection and discovery of the issue. The issue is then rectified by placing one or more shunt connectors at right location(s) (i.e., pin pair(s)). Thus, each of the resistors R1, R2, and R3 may be, and in some embodiments are, selectively connected in parallel with the resistor R4 via a shunt connector across the corresponding pin pair P1, P2, and P3 of the multi-pin header block 208a. This results in a change in resistance provided to the drain of the switching element Q1, which results in a corresponding change in the current of the primary side of the transformer T1, which in turn will change the current on the secondary side of the transformer T1, and thus changes the current on the output channel 204a to the light source stage 205a. Though the multi-pin header block 208a shown in FIG. 2A includes four resistors and three pin pairs, of course, in some embodiments, more resistors and/or pin pairs are present, and in some embodiments, fewer resistors and/or pin pairs are present, and in some embodiments, there are combinations thereof. In some embodiments, all the of the resistors of the multi-pin header block are shuntable, to provide a greater range of flexibility with respect to setting the output current on the output channel.

With further reference to FIG. 2A, the multi-pin header block 208a receives the current from the primary side of the transformer T1. Because the multi-pin header block 208a effectively acts as a variable resistor, based on how and how many shunt connectors are attached or not attached across the pin pairs P1, P2, and P3, and this resistance governs the current on the primary side of the transformer T1, it is used to selectively set the current on the secondary side of the transformer T1, which is the output current provided at the output channel 204a of the converter stage 203a. For example, with no shunt connector, a first amount of current (e.g., X) passes through the multi-pin header block 208a. With a single shunt connector located across the pin pair P1, a second amount of current (e.g., 2X) passes through the multi-pin header block 208a. With a single shunt connector located across the pin pair P2, a third amount of current (e.g., 2.5X) passes through the multi-pin header block 208a. With a single shunt connector located across the pin pair P3, a fourth amount of current (e.g., 3X) passes through the multi-pin header block 208a. Thus, the multi-pin header block 208a and the shunt connector(s), if any, effectively set the output current on the output channel 204a of the converter stage 203a. Of course, though FIG. 2A refers to a flyback converter, other suitable converter topologies may be, and in some embodiments are, used.

The particular output current on the output channel 204a is set, in some embodiments, to correspond to one or more flux bins of the solid state light sources SSLa . . . SSLn to be powered by the driver circuit including the input stage 201a and the converter stage 203a. This allows for a single driver circuit to be used to produce a variety of products, some of which may have different lumen outputs and some of which may have different color temperatures. Example of possible multi-pin header block 208a/shunt connector combinations for a variety of products that use the driver circuit of FIG. 2A is shown below in Table 1:

TABLE 1
Example header configurations for various light outputs/products

| Product | Product Description | Header Configuration |
|---|---|---|
| 1100 lm 2700K | 1100 lm B10 2700K | Shunt connector on |
| | | pin pair P2 |
| | 1100 lm B11 2700K | Shunt connector on |
| | | pin pair P3 |
| 1100 lm 3000K | 1100 lm B10 3000K | Shunt connector on |
| | | pin pair P3 |
| | 1100 lm B11 3000K | No shunt connector |
| 1100 lm 3500K | 1100 lm B10 3500K | Shunt connector on |
| | | pin pair P3 |
| | 1100 lm B11 3500K | No shunt connector |
| 1400 lm 2700K | 1400 lm B10 2700K | Shunt connectors on |
| | | pin pair P1 and pin |
| | | pair P2 |
| | 1400 lm B11 2700K | Shunt connector on |
| | | pin pair P1 |
| 1400 lm 3000K | 1400 lm B10 3000K | Shunt connector on |
| | | pin pair P1 |
| | 1400 lm B11 3000K | Shunt connectors on |
| | | pin pair P2 and pin |
| | | pair P3 |
| 1400 lm 3500K | 1400 lm B10 3500K | Shunt connector on |
| | | pin pair P1 |
| | 1400 lm B11 3500K | Shunt connectors on |
| | | pin pair P2 and pin |
| | | pair P3 |

As can be seen, a number of distinct products are available, including 1100 lumen (lm) and 1400 lm families, each including a number of color temperatures (e.g., 2700K, 3000K, 3500K). In addition, each product is associated with a flux bin (e.g., B10 or B11) for a given color temperature. Although only two flux bins are shown, any number of flux bins could be used, as will be appreciated in light of this disclosure. In any such embodiments, a corresponding header configuration may be provided for each possible available light source product, as further shown in Table 1. Note that some of the products call for no shunt connectors, some call for one shunt connector, and others call for multiple shunt connectors.

In one specific example embodiment configured with a flyback topology as shown in FIG. 2A, the external source 199 is a 108 VAC to 132 VAC, with an input current of about 1 A (e.g., pulse width less than or equal to 20 microseconds). With further reference to the example light sources indicated in Table 1, the output power for the light source stage 205a is about 15 W, with an output current on the output channel 204a of about 480 mA +/−10% for 1400 lumen output, and an output current of 390 mA +/−10% for 1100 lumen output. The output voltage is about 36 VDC.

FIG. 2B schematically illustrates a topology for a converter stage 203b, including an input stage 201b, which is configured to receive power from an external source 199b of power, and to rectify and filter the received power to provide an input to the converter stage 203b. The converter stage 203b is configured with a boost topology, including an inductor L1, a diode D1, a capacitor C1, and a switching element Q1 that is responsive to a control signal 210b from a microcontroller 209b. The converter stage 203b also includes a multi-pin header block 208b. The load connected to converter stage 203b is a light source stage 205b, which includes a string of solid state light sources SSLa . . . SSLn. The inductor L1 is connected to the input stage 201a and to an anode of the diode D1. The anode of the diode D1 is also connected to a source of the switching element Q1, which is shown in FIG. 2B as a p-channel type MOSFET. A gate of the switching element Q1 is connected to the microcontroller 209b. A drain of the switching element Q1 is connected to the multi-pin header block 208b, which is also connected to the input stage 201b. A cathode of the diode D1 is connected to the light source stage 205b. The capacitor C1 is connected between the cathode of the diode D1 and the multi-pin header block 208b. In operation, the boost converter stage 203b generally includes an on-state and an off-state. In the on-state, the switching element Q1 is closed via the control signal 210b from the microcontroller 209b, which causes an increase in a current through the inductor L. In the off-state, the switching element Q1 is open via the control signal 210b from the microcontroller 209b, so the only path for the current in the inductor L1 is through the diode D1, the capacitor C1, and the light source stage 205b, such that energy accumulated during the on-state is transferred into the capacitor C1. The input current is the same as the inductor current, so it is not discontinuous as in a buck converter topology and the requirements on the input filter are relaxed compared to a buck converter topology.

The multi-pin header block 208b of FIG. 2B includes four resistors R1, R2, R3, and R4 in parallel, with the resistor R4 always connected and the remaining resistors R1, R2, and R3 connectable via a corresponding pin pair P1, P2, and P3 for each. By adding a shunt connector (not shown in FIG. 2A) across one or more of the pin pairs P1, P2, and P3, the corresponding resistor R1, R2, and/or R3 is connected, while removing an existing shunt connector from a pin pair disconnects the corresponding resistor. The multi-pin header block 208b is configured to shunt a portion of the output current on an output channel 204b so as to reduce the actual output current provided to the light source stage 205b. Though FIG. 2B shows the resistor R4 as always in circuit, in other embodiments R4 includes its own respective pin pair and thus is capable of being shunted or not. To this end, the value of the resistor R4 is set based on the desired maximum output drive current. In addition, each of the resistors R1, R2, and R3 is able to be selectively connected in parallel with R4 via respective shunt connectors across the corresponding pin pairs P1, P2, and P3 of the multi-pin header block 208b, to change the resistance of the multi-pin header block 208b, which will effect the amount of diverted current, which in turn will effect the amount of the output current delivered to the light source stage 205b. As previously explained with respect to FIG. 2A, some embodiments have all of the resistors R1, R2, R3, and R4 of the multi-pin header block 208b be shuntable (rather than have the resistor R4 hardwired in circuit), to provide a flexibility with respect to setting the output current. So, the minimum amount of current diverted from the light source stage 205b is when no shunt connectors are installed (only the resistor R4 is in circuit, or no resistors are in circuit), and installing one or more of the shunt connectors across one or more of the pin pairs P1, P2, and P3 has the effect of changing the overall shunt resistance of the multi-pin header block 208b, thereby changing the amount of current diverted from the light source stage 205b.

With further reference to FIG. 2B, the multi-pin header block 208b receives the current diverted from the output channel 204b via the path provided when the switching element Q1 is closed. Because the multi-pin header block 208b effectively acts as a variable resistor based on how the shunt connectors are attached or not attached across the pin pairs P1, P2, and P3, which governs the amount of diverted current, it is used to selectively set the current provided at the output channel 204b of the converter stage 203b. For example, with no shunt connector, a first amount of current (e.g., X) passes to the light source stage 205b. With a single shunt connector located across the pin pair P1, a second amount of current (e.g., 0.85X) passes to the light source stage 205b. With a single shunt connector located across the pin pair P2, a third amount of current (e.g., 0.75X) passes to the light source stage 205b. With a single shunt connector located across the pin pair P3, a fourth amount of current (e.g., 0.5X) passes to the light source stage 205b. Thus, the multi-pin header block 208b and the shunt connector(s), if any, effectively set the output current of the converter stage 203b on the output channel 204b.

FIG. 2C schematically illustrates another topology for an input stage 201c and a converter stage 203c. In FIG. 2C, the input stage 201c includes a bridge of diodes D1, D2, D3, and D4 configured to receive power from an external source 199c of power, and to rectify and filter it to provide energy to the converter stage 203c. The converter stage 203c is set up according to a buck topology, and includes an inductor L1, a diode D5, a capacitor C1, and a switching element Q1 that is responsive to a control signal 210c from a microcontroller 209c. The converter stage 203c also includes a multi-pin header block 208c. The converter stage 203c provides an output current via an output channel 204c to a light source stage 205c, which includes one or more solid state light sources configured in any known way. A source of the switching element Q1, which is shown in FIG. 2C as a p-channel type MOSFET, is connected to the input stage 201c, which is also connected to an anode of the diode D5 and to the multi-pin header block 208c. A cathode of the diode D5 is connected to a drain of the switching element Q1. A gate of the switching element Q1 is connected to the microcontroller 209c. The cathode of the diode D5 is also connected to the inductor L1, which is also connected to the light source stage 205c. The capacitor C1 is connected in parallel across the light source stage 205c. The multi-pin header block 208c is also connected to the light source stage 205c. In operation, the buck converter stage 203c includes an on-state and an off-state. In the on-state, the switching element Q1 is closed via the control signal 210c from the microcontroller 209c, and current through the inductor L1 rises linearly. The diode D5 is reverse-biased by the conditioned input voltage provided by the input stage 201c, and thus no current flows through it. In the off-state, the switching element Q1 is opened via the control signal 210c from the microcontroller 209c, and the diode D5 is forward biased, and the current through the inductor L1 decreases. In a similar fashion to the multi-pin header block 208b shown in the boost topology of FIG. 2B, the multi-pin header block 208c of FIG. 2C includes four resistors R1, R2, R3, and R4, except in FIG. 2C, the multi-pin header block 208c is positioned so as to govern the output current by setting the current flow through the light source stage 205c. In addition, the microcontroller 209c of FIG. 2C is further configured to sense at least one of the voltage across the multi-pin header block Vₛₑₙₛₑ and/or the current through the inductor L, Iₛₑₙₛₑ, as shown with dashed sense lines. The microcontroller 209c makes these current and/or voltage measurements and then invokes one or more control actions, which include, for example but not limited to, prompting or otherwise directing placement of a shunt connector on a specific pin pair P1, P2, and P3 of the multi-pin header block 208c to achieve a desired light output from the light source stage 205c. In some embodiments, the multi-pin header block is positioned in the buck circuit so as to divert a portion of total drive current away from the light source stage, thereby controlling the drive current in a similar fashion as discussed with the boost example of FIG. 2B. As will be further appreciated, the multi-pin header block 208c is connected in series with the light source stage 205c for a boost circuit as well, so as to provide another variation.

With further reference to FIG. 2C, the multi-pin header block 208c is in series with the light source stage 205c, and therefore receives the same current as the light source stage 205c. Because the multi-pin header block 208c effectively acts as a variable resistor, based on how and how many shunt connectors are attached or not attached, that directly governs the amount of current through the light source stage 205c, and so it is used to selectively set the output current provided at the output channel 204c of the converter stage 203c. For example, with no shunt connector, a first amount of current (e.g., X) passes to the light source stage 205c. With a single shunt connector located across the pin pair P1, a second amount of current (e.g., 1.25X) passes to the light source stage 205c. With a single shunt connector located across the pin pair P2, a third amount of current (e.g., 1.75X) passes to the light source stage 205c. With a single shunt connector located across the pin pair P3, a fourth amount of current (e.g., 2X) passes to the light source stage 205c, and so on. Thus, the multi-pin header block 208c and the shunt connector(s), if any, effectively set the output current of the converter stage 203c.

As will be appreciated in light of this disclosure, numerous variations on the topologies shown in FIGS. 2A-2C, as well as other driver topology schemes, may be and in some embodiments are used, and the claimed invention is not intended to be limited to any particular one, unless otherwise expressly stated.

FIG. 3A shows a driver layout that includes a multi-pin header block 208d on a substrate 400 including various other electrical components for a driver circuit, such as but not limited to the driver circuit 100 shown in FIG. 1. The other electrical components may be, and in some embodiments are, implemented in any desired driver configuration, and the multi-pin header block 208d may be, and in some embodiments is, manipulated as described throughout to set the output current of the driver circuit on the substrate 400, as will be appreciated in light of this disclosure. As shown in greater detail in FIG. 3B, the multi-pin header block 208d includes three pin pairs P1, P2, and P3, each comprising two pins P1A and P1B, P2A and P2B, and P3A and P3B. FIG. 3C shows a shunt connector 500 placed across the pin pair P3 at the top of the multi-pin header block 208d. With reference to the embodiments of FIG. 2A-2C, this would effectively place the resistor R4 in parallel with the resistor R3, for instance. As previously explained, in some embodiments, multiple shunt connectors are used to cause further changes to the resistance of the multi-pin header block 208d, resulting in corresponding changes to the output current, while in some embodiments no shunt connectors are used, thus shunting the minimum amount of current through the resistor R4. As will be appreciated in light of this disclosure, the multi-pin header block may be, and in some embodiments is, located in any suitable location of the driver layout and/or on the substrate 400, such as electrically connected in series with the modulation element (e.g., the switching element Q1) of the driver circuit, or in any other location where manipulating the shunt resistance is used to effectively set the output current of that particular output channel. In some embodiments, for instance, the multi-pin header block is located within a control section of the converter stage, between the switching element and the return line, such as shown in FIGS. 2A-2C. In some embodiments, the multi-pin header block is part of the microcontroller or another microcontroller connected to the driver circuit. In some embodiments, such as those shown in FIGS. 3A-3C, the multi-pin header block is a discrete component.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A method, comprising:
receiving input power at a light driver circuit comprising a plurality of output channels, wherein the plurality of output channels comprises a first output channel and a second output channel;
setting an output current for at least a first output channel and a second output channel in the plurality of output channels by using a respective multi-pin header block, such that an output current of the first output channel of the light driver circuit is set by using a first multi-pin header block and an output current of the second output channel of the light driver circuit is set by using a second multi-pin header block; and
providing the output current of the first output channel to a first light source and the output current of the second output channel to a second light source.

2. The method of claim 1, wherein providing comprises:
providing the output current of the first output channel to a first light source, associated with a first flux bin and the output current of the second output channel to a second light source associated with a second flux bin.

3. The method of claim 1, wherein setting comprises:
using one of the first multi-pin header block and the second multi-pin header block to divert a portion of a total current associated with a respective output channel in the plurality of output channels corresponding to the used multi-pin header block from being provided to a respective light source associated with the respective output channel.

4. The method of claim 1, wherein setting comprises:
using one of the first multi-pin header block and the second multi-pin header block to set a primary-side current of a respective isolation transformer corresponding to a respective output channel in the plurality of output channels corresponding to the used multi-pin header block.

5. The method of claim 1, further comprising:
connecting the first multi-pin header block in series with the first light source and connecting the second multi-pin header block in series with the second light source.

6. The method of claim 1, wherein setting further comprises:
installing or removing a shunt connector from at least one of the first multi-pin header block and the second multi-pin header block, wherein a position of a shunt connector on the first multi-pin header block is different from a position of a shunt connector on the second multi-pin header block.

7. A driver, comprising:
a first converter stage configured with a first output channel to provide a current to a first light source; and
a first multi-pin header block configured to set the current of the first output channel, comprising a plurality of first pin-pairs, each capable of receiving a shunt connector.

8. The driver of claim 7, further comprising:
a second converter stage configured with a second output channel to provide a current to a second light source; and
a second multi-pin header block configured to set the current of the second output channel, comprising a plurality of second pin-pairs, each capable of receiving a shunt connector.

9. The driver of claim 8, wherein the first light source is associated with a first flux bin, and wherein the second light source is associated with a second flux bin.

10. The driver of claim 8, wherein the second multi-pin header block diverts a portion of a total current of the second converter stage from being provided to the second light source.

11. The driver of claim 8, wherein the second converter stage comprises an isolation transformer, and wherein the second multi-pin header block sets a primary-side current of the isolation transformer.

12. The driver of claim 7, further comprising an input stage to condition input power and to provide the conditioned input power to the first converter stage.

13. The driver of claim 7, wherein the first multi-pin header block diverts a portion of total current of the first converter stage from being provided to the first light source.

14. The driver of claim 7, wherein the first converter stage comprises an isolation transformer, and wherein the first multi-pin header block sets a primary-side current of the isolation transformer.

15. The driver of claim 7, wherein the first multi-pin header block is configured to be electrically connected in series with the first light source.

16. The driver of claim 7, further comprising:
a controller configured to sense current through the first light source and to take a control action, wherein the control action includes directing placement of a shunt connector on the first multi-pin header block.

17. A lighting system, comprising:
a first converter stage configured with a first output channel to provide a current to a first light source;
a first multi-pin header block configured to set the current of the first output channel, and comprising a plurality of first pin-pairs, each capable of receiving a shunt connector;
a second converter stage configured with a second output channel to provide a current to a second light source; and
a second multi-pin header block configured to set the current of the second output channel, and comprising a plurality of second pin-pairs, each capable of receiving a shunt connector;
wherein at least one of the current of the first output channel and the current of the second output channel is set by installing and/or removing one or more shunt connectors from at least one of the first multi-pin header block and the second multi-pin header block; and
wherein the first converter stage and the second converter stage are implemented with a single multi-channel driver or two single-channel drivers.

18. The lighting system of claim 17, wherein at least one of the first multi-pin header block and the second multi-pin header block diverts a portion of a total current of the corresponding converter stage from being provided to the corresponding light source.

19. The lighting system of claim 17, wherein at least one of the first converter stage and the second converter stage comprises an isolation transformer, and the corresponding multi-pin header block sets a primary-side current of the corresponding isolation transformer.

20. The system of claim 17, further comprising:
a controller configured to sense a current through the first light source and to take a control action, wherein the control action includes directing placement of a shunt connector on the first multi-pin header block.
